(19) United States
(12) Patent Application Publication
(10) Pub. No.: US 2009/0022940 A1
(43) Pub. Date: Jan. 22, 2009

(54) METHOD FOR PRODUCING A FOLDED CORE STRUCTURE AND PRE-IMPREGNATED SEMI-FINISHED FIBRE COMPONENT

(76) Inventors: Hans-Jurgen Weber, Verden (DE); Gregor Christian Endres, Pfaffenhofen (DE)

Correspondence Address: OCCHIUTI ROHLICEK & TSAO, LLP, 10 FAWCETT STREET, CAMBRIDGE, MA, 02138, US

(21) Appl. No.: 12/175,603

(22) Filed: Jul. 18, 2008

Related U.S. Application Data
(60) Provisional application No. 60/950,999, filed on Jul. 20, 2007.

(51) Int. Cl. B32B 5/14

(52) U.S. Cl. 428/113; 264/482

(57) ABSTRACT

The present invention relates to a method for producing a folded core structure, particularly in the aerospace field, comprising the following steps: Initially a low-cross-linked, pre-impregnated semi-finished fibre component is provided. Subsequently heat is brought into predetermined regions of the pre-impregnated semi-finished fibre component, particularly using a laser, so as to highly cross-link the resin matrix in predetermined regions and so as to consequently generate a pattern of low-cross-linked and high-cross-linked regions in the semi-finished pre-impregnated fibre component. In a further step, of the method the pre-impregnated semi-finished fibre component is folded along the low-cross-linked regions that serve as hinges. Hereupon, the folded, pre-impregnated semi-finished fibre component is cured to the folded core structure. Compared to the known embossing method, in the method according to the invention an extensive tool for supporting the pre-impregnated semi-finished fibre component after the folding is advantageously omitted. Moreover, using the method according to the invention also tissue-like semi-finished fibre components can be processed to folded core structures.

### CROSS-REFERENCE TO RELATED APPLICATIONS

This application claims the benefit of U.S. Provisional Application No. 60/950,999 filed Jul. 20, 2007, the entire disclosure of which is herein incorporated by reference.

### FIELD OF THE INVENTION

The present invention relates to a method for producing a folded core structure and to a pre-impregnated semi-finished fibre component, particularly in the aerospace field.

### BACKGROUND OF THE INVENTION

Due to their good stiffness and/or rigidity to density ratio core compounds have a wide application range in the aerospace field. Core compounds are generally composed of an upper and a lower layer between which a core structure is arranged for increasing the stiffness.

Honeycomb materials comprising cells with hexagonal cross-section extending vertically to the upper and lower layer are an example of such widely known core structures.

The so-called folded core structures are a further well-known example. Therein flat semi-finished fibre components, for instance made of paper, are folded to a spatial core structure. Advantageously such folded core structures can be produced with little energy input. Moreover, folded core structures are lightweight, bulge resistant, suitable for drainage, soundproof and can be adapted easily to the expected mechanical loads. In case of repeating patterns, the folded core structures can also be produced endlessly.

A known method for producing a folded core structure is the so-called embossing method using a plotter. The plotter produces line-shaped embossed regions on a flat semi-finished fibre component using an embossing pin. In a further step the semi-finished fibre component is folded along the embossed regions. Subsequently, the folded semi-finished fibre component is arranged on a tool holding the folded semi-finished fibre component in the folded state. Hereupon, the folded semi-finished fibre component along with the tool is exposed to pressure and heat for curing the semi-finished fibre component to the folded core structure.

Problematic about the previously described method is that in case of tissue-like semi-finished fibre components the embossing pin entangles itself in the semi-finished fibre components or that the embossed regions cannot be produced permanently because they return to their original state after a certain period of time.

In the known method, the folded semi-finished fibre component comprises virtually no rigidity and without the support of the tool it would therefore change its shape after the folding in such a manner such that compliance with the form tolerances would be impossible. Such tools are very demanding with respect to their production as they have to comply with the sometimes very complex geometries of the folded semi-finished fibre component.

### SUMMARY OF THE INVENTION

Thus, an object of the present invention is to provide an improved method for producing a folded core structure which can also be applied to tissue-like semi-finished fibre components and/or which does not require the previously described tool. Furthermore, an object of the present invention is to provide a pre-impregnated semi-finished fibre component that can be folded easily and/or which exhibits sufficient rigidity in the folded state.

According to the invention this object is achieved by a method comprising the features of claim 1 and/or by a pre-impregnated semi-finished fibre component comprising the features of claim 3.

Accordingly a method for producing a folded core structure, particularly in the aerospace field, comprising the following steps is provided: Initially a low-cross-linked, pre-impregnated semi-finished fibre component is provided. Subsequently, heat is applied to predetermined regions of the pre-impregnated semi-finished fibre component. Thereby, a high cross-linking is generated in these predetermined regions. The high-cross-linked regions together with the regions omitted during the heat supply and thus still low-cross-linked regions form a pattern of low-cross-linked and high-cross-linked regions in the pre-impregnated semi-finished fibre component. Compared to the high-cross-linked regions the low-cross-linked regions are deformable and do therefore constitute hinges for folding the semi-finished fibre component. In a further step, the pre-impregnated semi-finished fibre component is folded along the low-cross-linked regions (hinges). Hereupon, the folded pre-impregnated semi-finished fibre component is cured to the folded core structure.

Moreover, a pre-impregnated semi-finished fibre component is provided, particularly in the aerospace field, comprising a pattern of low-cross-linked regions and high-cross-linked regions wherein the low-cross-linked regions are designed as hinges between the high-cross-linked regions for folding the pre-impregnated semi-finished fibre component along the low-cross-linked regions.

One idea the present invention is based on is that hinge-like folding regions can be generated contactlessly in a semi-finished fibre component by locally varying the heat introduced into the semi-finished fibre component. Therein, no mechanical interaction on the semi-finished fibre component as for instance in the embossing method is required for generating the defined hinge-like folding regions. Therewith, tissue-like semi-finished fibre components can also be processed easily to folded core structures using the method according to the invention. Also, returning of the folding regions after a certain period of time as in the embossing method is prevented in the method according to the invention in that the semi-finished fibre component is locally changed in its molecular structure and not locally changed mechanically.

The high-cross-linked regions are comparatively stiff and have a high softening temperature. This facilitates that the folded semi-finished fibre component keeps its shape during the hardening also without a supporting tool. Therefore, the supporting tool is no more required, which leads to considerable cost advantages.

Advantageous embodiments and improvements of the invention are presented in the dependent claims.

“Pre-impregnated half-finished fibre component” encompasses every kind of fibre tissue, fibre lay-up or fibre felt which has been impregnated with a matrix, particularly with an epoxy-resin matrix. Preferably, the half-finished fibre component has a flat shape, particularly with a thickness in the range of 0.01 to 5 millimetres.

“Cross-linking” means the cross-linking of the matrix.

A “low-cross-linked” region exhibits a lower degree of cross-linking than a “high-cross-linked” region.

“Low-cross-linked” also encompasses a degree of cross-linking of zero.

According to a preferred embodiment of the method, the application of heat is performed by means of a laser. A laser allows for a very exact and precise application of heat energy to the predetermined regions. Moreover, lasers work very fast. Therewith, short production times for the folded core structure can be achieved. In addition, lasers can be controlled very flexibly, in particular by means of a suitable NC-controller. Therewith, geometrically different patterns can be generated on the semi-finished fibre components and also the set-up times between different patterns are minimal.

Naturally, the folded core structure can be arranged between the top and bottom layer before or after its curing and can be cured along with the top and bottom layer, particularly using pressure and/or heat, to a core compound and/or can be glued to the top and bottom layer.

### BRIEF DESCRIPTION OF THE DRAWINGS

In the following, the invention will be explained in more detail with reference to the appended drawings.

The figures show:

FIG. 1 a state of the method according to an embodiment of the invention; and

FIG. 2 a further state of the method according to the embodiment.

The same reference signs in the figures denote the same or functionally equivalent components if not indicated to the contrary.

### DETAILED DESCRIPTION OF THE DRAWINGS

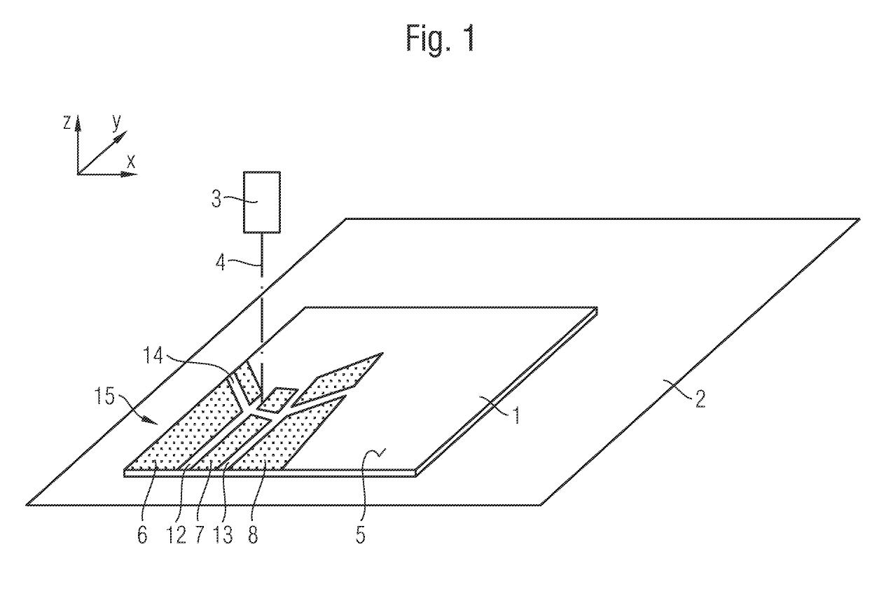

FIG. 1 shows a planar semi-finished fibre component 1 which is formed as a carbon fibre tissue pre-impregnated with an epoxy resin matrix. Initially, the entire epoxy resin matrix in the semi-finished fibre component is in a low-cross-linked state with a degree of cross-linking of 5%, for instance. The semi-finished fibre component 1 is arranged on a processing table 2.

A laser 3 that generates a laser beam 4 onto the surface 5 of the semi-finished fibre component 1 is arranged above the semi-finished fibre component 1.

The laser 3 and/or the laser beam 4 is preferably movable in all three spatial directions X, Y and Z and/or can be rotated about these so that the laser beam 4 is able to process semi-finished fibre components 1 with arbitrarily contoured surfaces 5 (particularly in z-direction). Preferably, the laser 3 is provided on an arm of a portal robot (not shown) and is movable by a NC-control.

The laser beam 4 is moved over the dark illustrated, predetermined regions (indicated by reference sign 6, 7 and 8 for instance) of the surface 5 of the semi-finished fibre component 1.

The high energy introduced into these predetermined regions 6, 7, 8 by the laser beam 4 results in that the epoxy resin in these predetermined regions 6, 7, 8 cross-links and therewith these regions harden at least partially. For instance, the degree of cross-linking in these regions is then equal to 80%.

The regions (indicated by the reference signs 12, 13 and 14 for instance) omitted by the laser beam 4 exhibit the epoxy resin matrix in the low-cross-linked state.

Therewith, a pattern 15 of high-cross-linked and low-cross-linked regions 6, 7, 8; 12, 13, 14 is generated in the semi-finished fibre component 1. As the semi-finished fibre component 1 is proportionally thin and as the energy introduced by the laser 3 is very high, the regions 6, 7, 8 are also highly cross-linked, preferably right through the thickness in the z-direction.

Consequently, a pattern 15 of high-cross-linked and low-cross-linked regions 6, 7, 8; 12, 13, 14 is generated wherein the low-cross-linked regions are deformable compared to the high-cross-linked regions 6, 7, 8 and thus the low-cross-linked regions serve as hinges for the subsequent folding of the semi-finished fibre component 1.

In the state shown in FIG. 1 only a portion of the semi-finished fibre component 1 has been processed by the laser 3.

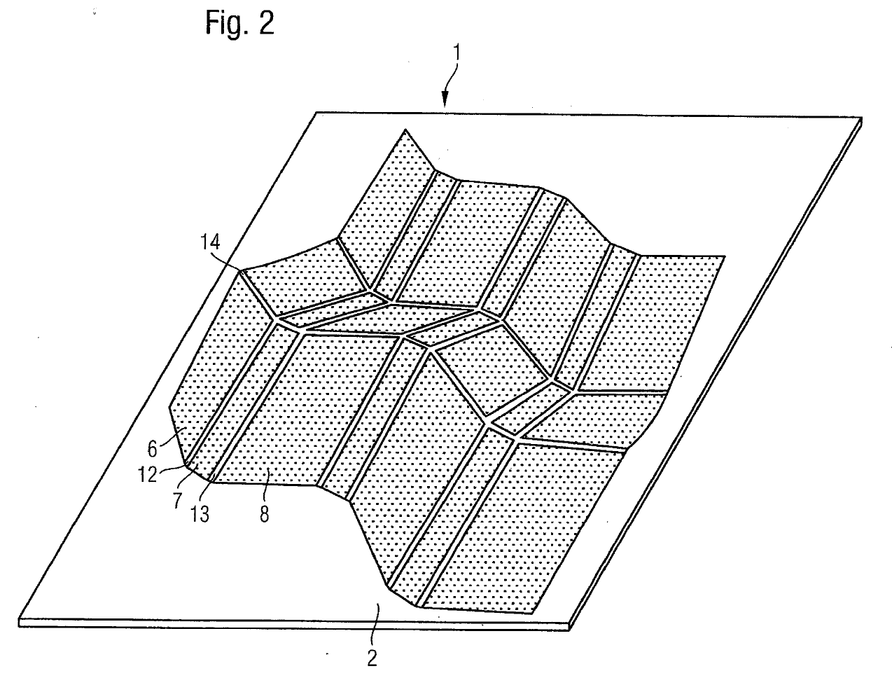

After all regions 6, 7, 8 have been high-cross-linked by the laser 3 (laser beam 4) the semi-finished fibre component 1 is folded along the low-cross-linked regions 12, 13, 14 by means of a folding device not shown and then the semi-finished fibre components exhibits the shape shown in FIG. 2.

As the high-cross-linked regions 6, 7, 8 already exhibit a certain rigidity the folded semi-finished fibre component 1 keeps the state shown in FIG. 2, also without a tool that is adapted to the geometry of the folded semi-finished fibre component 1 supporting the semi-finished fibre component 1.

In a further step of the method the folded semi-finished fibre component shown in FIG. 2 can be can be provided with a lower and an upper layer (not shown), and then the entire arrangement, comprising the folded semi-finished fibre component 1 and the upper and the lower layer, particularly made of pre-impregnated but not yet hardened semi-finished fibre components, can be cured using pressure and/or heat.

Instead of the laser 3 other dense energy sources which can be focused, as for instance a microwave device, are conceivable.

Advantageously, the method shown in FIGS. 1 and 2 runs continuously, i.e. the semi-finished fibre component 1 is provided as an endless semi-finished fibre component that can be uncoiled from a spindle for instance, the endless semi-finished fibre component running for instance in Y-direction over the processing table 2.

Although the present invention has been described by means of preferred embodiments, it is not restricted thereto but it is modifiable in a number of ways.

The present invention relates to a method for producing a folded core structure, particularly in the aerospace field, comprising the following steps: Initially a low-cross-linked, pre-impregnated semi-finished fibre component is provided. Subsequently, heat is brought into predetermined regions of the pre-impregnated semi-finished fibre component, particularly using a laser, so as to highly cross-link the resin matrix in predetermined regions and so as to consequently generate a pattern of low-cross-linked and high-cross-linked regions in the semi-finished pre-impregnated fibre component. In a further step of the method, the pre-impregnated semi-finished fibre component is folded along the low-cross-linked regions that serve as hinges. Hereupon, the folded, pre-impregnated semi-finished fibre component is cured to the folded core structure. Compared to the known embossing method, in the method according to the invention, an extensive tool for supporting the pre-impregnated semi-finished fibre component after the folding is advantageously not required. Moreover, using the method according to the invention also tissue-like semi-finished fibre components can be processed to folded core structures.

1. A method for producing a folded core structure, particularly in the aerospace field, comprising the following steps:
Providing a low-cross-linked, pre-impregnated semi-finished fibre component;
Application of heat to predetermined regions of said pre-impregnated semi-finished fibre component for highly cross-linking said predetermined regions and therewith generating a pattern of low-cross-linked and high-cross-linked regions in said pre-impregnated semi-finished fibre component;
Folding said pre-impregnated semi-finished fibre component along said low-cross-linked regions; and
Curing said folded, pre-impregnated semi-finished fibre component to said folded core structure;
wherein the heat is applied contactlessly.

2. The method according to claim 1,
wherein said application of heat is carried out using a laser.

3. A pre-impregnated semi-finished fibre component, particularly in the aerospace field, comprising a pattern of low-cross-linked and high-cross-linked regions, wherein said low-cross-linked regions are designed as hinges between said high-cross-linked regions for folding said pre-impregnated semi-finished fibre component along said low-cross-linked regions.
